(19) United States
(12) Patent Application Publication
(10) Pub. No.: US 2026/0367850 A1
(43) Pub. Date: Nov. 19, 2026

(54) INDUSTRIAL PRINTING SYSTEM, PRINT SERVER, AND PROCESSING MANAGEMENT METHOD THAT PERFORMS OPTIMAL SCHEDULING USING MACHINE LEARNING IN PEER-TO-PEER MANNER

(71) Applicant: KYOCERA Document Solutions Inc., Osaka (JP)

(72) Inventor: Taku MATSUO, Los Angeles, CA (US)

(73) Assignee: KYOCERA Document Solutions Inc., Osaka (JP)

(21) Appl. No.: 19/211,474

(22) Filed: May 19, 2025

(51) Int. Cl. G06F 3/12

(52) U.S. Cl. CPC G06F 3/1261; G06F 3/1203; G06F 3/1282

(57) ABSTRACT

Provided is a distributed industrial printing system that performs optimal scheduling by using machine learning. The print server performs distributed processing of a plurality of jobs in an industrial printing system that performs production printing. DB stores the characteristic data and processing result data of processed jobs and processing performance data of component apparatuses. The learning unit learns a model for optimally allocating jobs to the component apparatus based on characteristic data, processing result data, and processing performance data stored in the DB. The processing management unit allocates unprocessed jobs to available space in the schedule based on output result of the model for an unprocessed job in accordance with instruction information that includes the condition to be prioritized and causes the corresponding component apparatus to process the unprocessed job or sends the unprocessed job to the other print servers to request processing.

### BACKGROUND

The present disclosure relates to an industrial printing system, a print server, and a processing management method that perform distributed processing in industrial printing (production printing).

In industrial printing, which is referred to as production printing and uses commercial (industrial) printing equipment, the components of the final product are produced in plurality of processes that are divided among different operators. For example, in the case of bookbinding, the cover, main body (color), main body (black and white), promotional materials, bands, and shipping envelopes are each processed as a separate job. Then, while combining each job in the middle of the process, the final product is finished as a book.

In such production printing system, a plurality of jobs that perform the same processing is managed collectively by a management server, and a large number of printing jobs are sometimes distributed and printed in an even manner.

As a typical technique, a method for scheduling print jobs on a plurality of printers, a non-transitory computer readable medium, and a system are disclosed. In this method, job information is collected for each of the plurality of print jobs. Then, each of the plurality of print jobs is assigned to one or more of the plurality of printers. Then, a new print job is received, and the pre-processing time for the new print job is calculated along with the job product information. Then, the processing time for the new print job is calculated. Then, one or more of the plurality of printers is determined to execute the new print job. Then, the new print job is assigned to at least one of the plurality of printers. Then, it is determined whether or not one or more of the plurality of print jobs can be reassigned to another printer to minimize the print schedule of the plurality of print jobs.

### SUMMARY

An industrial printing system of the present disclosure is an industrial printing system that performs production printing having a plurality of print servers for distributed processing of a plurality of jobs, each of the plurality of print servers including: a schedule management unit that manages scheduling setting of processing of a job for a component apparatus; a database that stores characteristic data and processing result data for processed jobs and processing performance data for the component apparatus; a learning unit that learns a model for optimally allocating jobs to the component apparatus based on the characteristic data, processing result data, and processing performance data stored in the database; and a processing management unit that allocates an unprocessed job to an available space in the schedule setting based on output result of the model for the unprocessed job in accordance with the instruction information including a condition to be prioritized, causes corresponding component apparatus to process the unprocessed job, or transmits the unprocessed job to other print server and request processing of the unprocessed job.

A print server of the present disclosure is a print server that performs distributed processing of a plurality of jobs in an industrial printing system that performs production printing, including: a schedule management unit that manages scheduling setting of processing of a job for a component apparatus; a database that stores characteristic data and processing result data for processed jobs and processing performance data for the component apparatus; a learning unit that learns a model for optimally allocating jobs to the component apparatus based on the characteristic data, processing result data, and processing performance data stored in the database; and a processing management unit that allocates an unprocessed job to an available space in the schedule setting based on output result of the model for the unprocessed job in accordance with the instruction information including a condition to be prioritized, causes

Corresponding component apparatus to process the unprocessed job, or transmits the unprocessed job to other print server and request processing of the unprocessed job.

A processing management method of the present disclosure is a processing management method executed by an industrial printing system that performs production printing having a plurality of print servers for distributed processing of a plurality of jobs, including the steps of: managing scheduling setting of processing of a job for a component apparatus; storing characteristic data and processing result data for processed jobs and processing performance data for the component apparatus; learning a model for optimally allocating jobs to the component apparatus based on the characteristic data, processing result data, and processing performance data that are stored; and allocating an unprocessed job to an available space in the schedule setting based on output result of the model for the unprocessed job in accordance with the instruction information including a condition to be prioritized, cause corresponding component apparatus to process the unprocessed job, or transmit the unprocessed job to other print server and request processing of the unprocessed job.

### BRIEF DESCRIPTION OF THE DRAWINGS

FIG. 1 is an example of a system configuration diagram of the industrial printing system of the present disclosure;

FIG. 2 is a block diagram showing a control configuration of the print server as shown in FIG. 1;

FIG. 3 is a block diagram showing a functional configuration of the print server as shown in FIG. 1;

FIG. 4 is a block diagram showing details of the schedule setting as shown in FIG. 3;

FIG. 5 is a block diagram showing details of the DB as shown in FIG. 3;

FIG. 6 is a block diagram showing details of the job as shown in FIG. 3;

FIG. 7 is a flowchart of the job order process according to the embodiment of the present disclosure; and

FIG. 8 is a conceptual diagram of the learning process as shown in FIG. 7.

### DETAILED DESCRIPTION

### Configuration of Industrial Printing System X

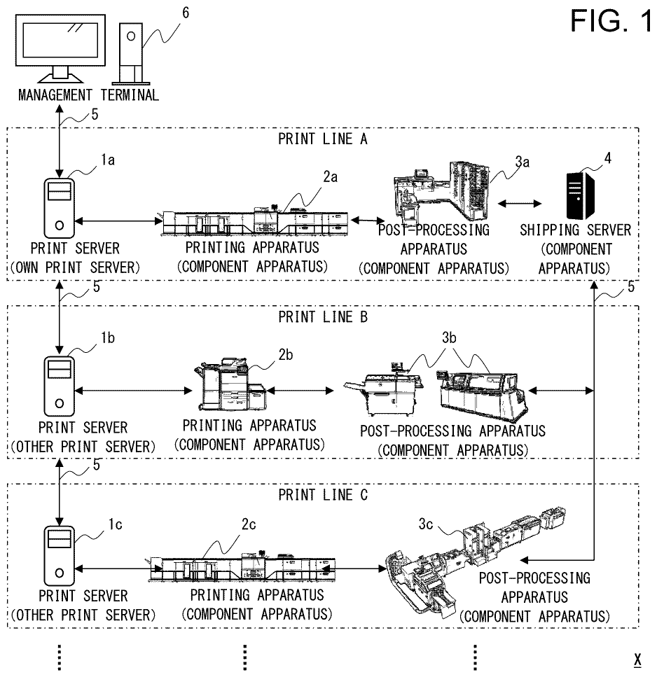

Firstly, as refer to FIG. 1, an example of the overall system configuration of the industrial printing system X according to the present embodiment is described.

The industrial printing system X according to the present embodiment is a system that executes the output of the printing process and post-processing process (hereinafter simply referred to as “printing”) in the industrial printing (production printing).

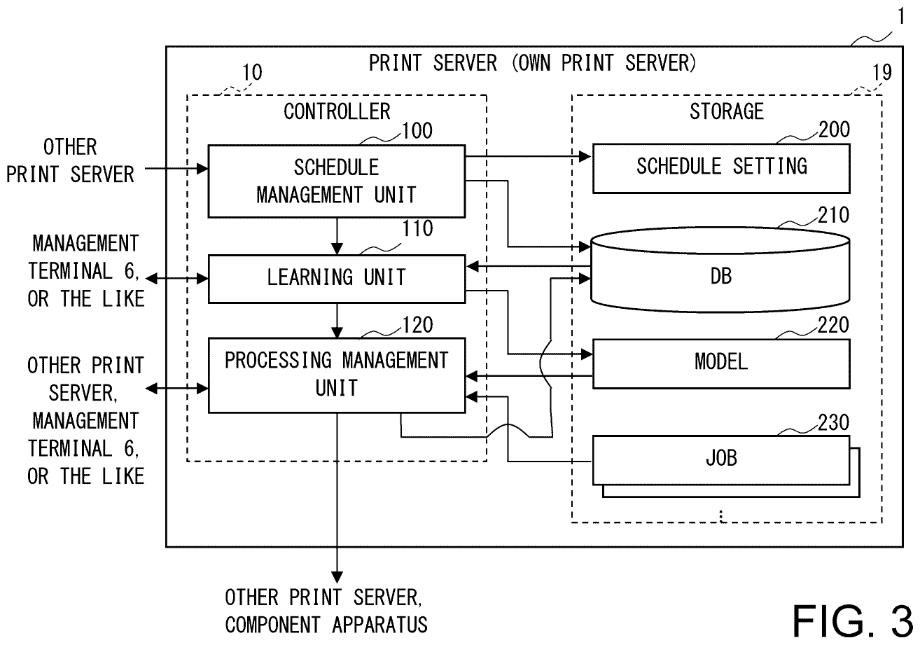

In the present embodiment, the industrial printing system X regards the final output of a book, or the like, as a “order,” and each component of the order is a job 230 (FIG. 3).

In the industrial printing system X, print servers 1 at the sites (printing lines,) which are printing companies, printing factories, and the like, are connected and linked with a network 5. A print servers 1 at each printing line controls printing-related apparatuses (hereinafter referred to as a “component apparatuses”) including the printing apparatus 2, the post-processing apparatus 3, and the shipping server 4, or the like. In addition, the management terminal 6 used by the administrator of the industrial printing system X and other users is also connected with the network 5.

FIG. 1 shows an example of the inter-site collaboration, in which the print servers 1a, 1b, 1c, . . . , for each of the printing lines A, B, C, . . . , and the shipping server 4 for printing line A are connected via the network 5. In addition, in this example, the printing apparatuses 2a, 2b, 2c, or the like, and post-processing apparatuses 3a, 3b, 3c, or the like, are connected to each print server 1a, 1b, 1c, or the like.

In the following, when referring to one of these print servers 1a, 1b, 1c, . . . , it is simply referred to as a print server 1. Similarly, when referring to one of the printing apparatuses 2a, 2b, 2c, . . . , it is simply referred to as a printing apparatus 2. Similarly, when referring to one of the post-processing apparatuses 3a, 3b, 3c, . . . , it is simply referred to as a post-processing apparatus 3.

The print server 1 is an information processing apparatus that operates as a print controller or a digital front end (DFE) to manage and control the component apparatuses installed at each site. The print server 1 is configured with a personal computer (PC), server, dedicated machine, general-purpose machine, or the like. In the present embodiment, the print server 1 allocates the processing of the job 230 to each component apparatus at the site and makes it execute the processing according to the schedule.

In the present embodiment, the print servers 1 at each site are connected to each other in a peer-to-peer manner and serve as distribution destinations for processing.

Furthermore, in the present embodiment, the print server 1 sends and receives various instructions and information with the printing apparatus 2, the post-processing apparatus 3, the shipping server 4, or the like, in production printing. As a result, the print server 1 manages the status of each apparatus and requests processing of the job 230.

Further, in the present embodiment, the print server 1 executes dedicated print management (order output management) application software (hereinafter simply referred to as “application”). As a result, the print server 1 performs peer-to-peer distributed processing of the job 230 (FIG. 3) for production printing. This print management application (hereinafter referred to as “dedicated application”) may be executed on a common platform. On the common platform, printing design creation, user management, tenant management, security management, notification services for maintenance, prepress processing management, document storage management, component apparatus management, or the like, may be performed.

In the present embodiment, the print server 1 that is the requesting side for the processing is referred to as the “own print server.” That is, the own print server is able to request processing of the job 230 (FIG. 3) stored in its own storage 19 to a print server 1 other than the own print server. The following describes an example in which the print server 1a is the own print server.

On the other hand, in the present embodiment, a print server 1 in the industrial printing system X other than the own print server is referred to as an “other print server.” In other words, the other print servers may be the ones that are requested to process the jobs 230 of the own print server. The following describes an example in which the print servers 1b and 1c are the other print servers.

Further, in the present embodiment, the own print server or the other print server may be set up for convenience, and the relationship between each print server 1 connected in a peer-to-peer manner may be equal. Therefore, each print server 1 may perform processing as either the own print server or the other print server depending on whether the job 230 is acquired by itself or is requested for processing.

The printing apparatus 2 is an industrial printer including an image forming apparatus, an automated offset printing apparatus, a digital printer, a multi-functional peripheral (MFP), or the like. The printing apparatus 2 is capable of performing printing processes such as small-lot printing or large-lot (multi-lot) offset printing.

The printing apparatus 2 at each site in the present embodiment may have different sizes, paper qualities, color profiles, recordable ranges, or the like, of the recording paper used in the printing process.

The post-processing apparatus 3 is capable of performing processing after printing (post-processing) such as folding, collating, binding, trimming, bookbinding, and the like, for the printed paper.

In the post-processing apparatus 3 at each site in the present embodiment, the content and range of processing that can be performed in the post-processing step may also be different.

The shipping server 4 is a server that manages the shipping of orders sent after printing or post-processing is completed at each site.

In the present embodiment, an example in which the shipping server 4 is installed at the site A is described. However, the shipping server 4 may also be installed at the other site.

The network 5 is a local area network (LAN), wireless LAN (Wi-Fi), wide area network (WAN), mobile phone network, industrial network, voice telephone network, other dedicated line, or the like. The network 5 is capable of sending and receiving various commands and data with each apparatus. Furthermore, the print server 1 and each component apparatus may also be connected via a local area network or other intranet within the network 5. In addition, the network 5 may also be configured as a virtual private network (VPN), or the like.

The management terminal 6 is an information processing apparatus such as a PC, smartphone, tablet terminal, personal data assistant (PDA), dedicated terminal, or the like. The management terminal 6 is used by the administrator of the industrial printing system X and other general users, or the like, to control printing. In the present embodiment, the management terminal 6 is capable of executing the dedicated application, connecting to the print server 1, and performing various settings and printing processing instruction (hereinafter referred to as “processing instruction”). In the present embodiment, this processing instruction includes instructions for an unprocessed job 230, a scheduling setting, a learning setting, cost and quality check, a condition setting, a cost estimate, or the like.

Thus, the management terminal 6 may include an input unit such as a keyboard or a pointing device, and a display unit such as a liquid crystal or organic light emitting diode (OLED or OEL) display, or the like. The input unit and the display unit may be integrally formed, such as a touch panel display.

In addition, the management terminal 6 can also execute an application that controls the design and prepress of production printing. Furthermore, the management terminal 6 may be connected with other input terminals, design proofreading terminals, or the like, for the design and prepress. Further, the management terminal 6 may have the function of a management apparatus that creates jobs 230 and manages the processing requests for each apparatus by the print server 1. This makes it possible to perform functions such as acquiring jobs 230, designing printing, submitting jobs, managing prepress processing, checking progress, requesting processing, and the like.

In addition, these apparatuses may exist in plurality of numbers depending on the application and scale of printing, or the like. Each apparatus can be connected with the print server 1 via the network 5 by using various protocols. Alternatively, the print server 1 and each apparatus can be directly connected by using various interfaces such as universal serial bus (USB), or the like.

In addition, each site may be provided with another component apparatus managed by the print server 1. The other component apparatus include, for example, terminals for submitting documents, terminals for design proofing, prepress apparatuses, or the like.

In addition, another general terminal used by a user may be connected with the network 5 inside and outside each site. The general terminal may include so-called a console.

As configured in this way, each print server 1 can be accessed by users by using the management terminal 6, the general terminal, or the like, via a web browser, terminal, dedicated application, or the like. This allows users to perform tasks such as acquiring the job 230, designing print, submitting a job, managing prepress processing, checking progress, requesting processing, and the like.

### Control Configuration of Print Server 1

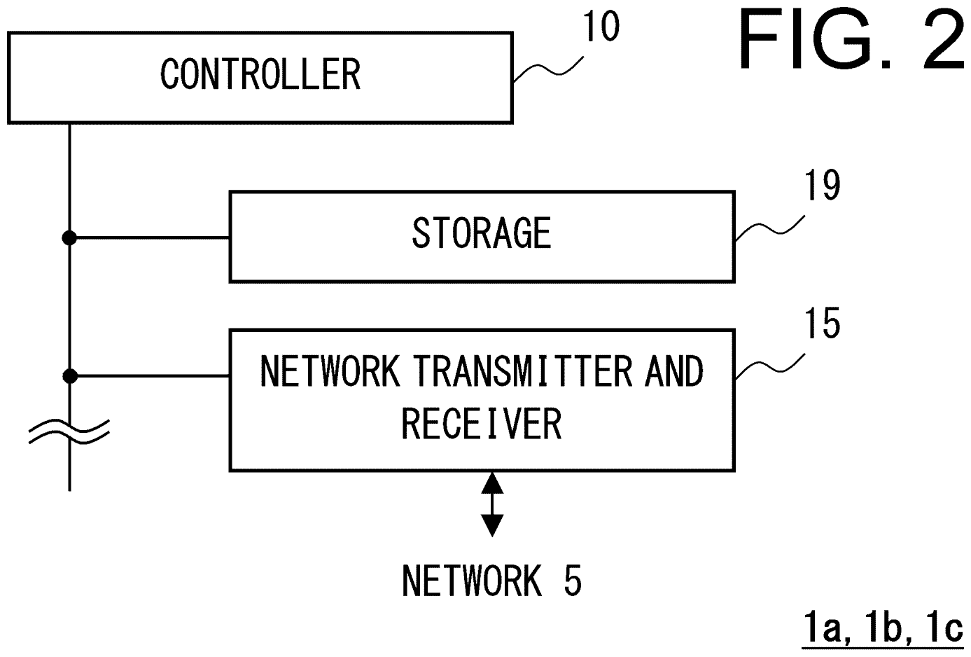

Next, as refer to FIG. 2, a control configuration of the print server 1 is explained. Here, an example in which the main configuration of the print server 1a, 1b, and 1c is the same is described.

The print server 1 includes a controller 10, a network transmitter and receiver 15, and a storage 19. Each unit is connected with the controller 10 and is controlled by the controller 10.

The controller 10 is a general electronic controller circuitry that performs information processing, such as a general purpose processor (GPP), a central processing unit (CPU), a micro processing unit (MPU), a digital signal processor (DSP), a graphics processing unit (GPU), a neural processing unit (NPU), an application specific integrated circuit (ASIC), or the like.

The controller 10 reads out the control program stored in the ROM or HDD of the storage 19, and by expanding the control program in the RAM and executing it, it can be made to operate as each unit of the functional block as described later. Further, the controller 10 controls the entire apparatus in response to instructions input from the management terminal 6 or general terminal.

The network transmitter and receiver 15 is a network connection unit that includes a LAN board and wireless transmitting and receiving unit for connecting to the network 5.

The network transmitter and receiver 15 transmits and receives data over data communication lines and transmits and receives voice signals over voice telephone lines.

The storage 19 is a non-transitory recording medium readable by a computer. The storage 19 includes semiconductor memories such as Read Only Memory (ROM) and Random Access Memory (RAM) or magnetic storage such as HDD (Hard Disk Drive). The ROM also includes rewritable memory such as flash memory.

The ROM and HDD of storage 19 store the control program for controlling the operation of the print server 1. The control program includes the operating system (OS), middleware on the OS, services (daemons), various applications, database data, or the like. Among these, the various applications include the dedicated applications such as print management applications, or the like, as described above.

In the present embodiment, the storage 19 may store programs and data for raster-in-process (hereinafter simply referred to as “rasterize” or “RIP”), which converts vector (line drawing) image data into dot image data (raster data) for printing. The programs and data for processing of rasterizing include commercial libraries and fonts, and the like.

Further, the storage 19 may also store information, control programs, or the like, for the component apparatuses connected with the same print line. Furthermore, the storage 19 may also store user account settings, other data, and the like, for the industrial printing system X.

In the print server 1, the controller 10 may be integrally formed, such as a CPU with a built-in GPU, a chip-on-module package, or a system on a chip (SOC).

The controller 10 may also incorporate RAM, ROM, flash memory, or the like.

### Functional Configuration of Print Server 1

Here, referring to FIGS. 3 to 6, the functional configuration of the print server 1 is explained.

The controller 10 of the print server 1 is provided with a schedule management unit 100, a learning unit 110, and a processing management unit 120.

The storage 19 stores a schedule setting 200, a DB 210, a model 220, and a job 230.

The schedule management unit 100 centrally manages the processing of the jobs 230 in component apparatuses by using the schedule setting 200. The schedule management unit 100 may manage the processing schedule of component apparatuses by using the schedule setting 200.

In the present embodiment, the schedule management unit 100 sets the access permission setting 201 so that the schedule setting 200 can be accessed by other print servers. In this case, the schedule management unit 100 sets the access permission setting 201 so that access from the other print servers is restricted for a specific period and/or specific component apparatuses of the schedule setting 200. The schedule management unit 100 refers to the access permission setting 201 and manages so that the job 230 are not allocated for this restricted period and/or specific component apparatuses.

Further, in the present embodiment, when there is a possibility of delay in delivery of the requested job 230, the scheduling management unit 100 of the other print server that has received the requested job 230 notifies the delay status to the own print server that is the requesting source.

In this case, the processing management unit 120 of the own print server that is the requesting source for job 230 can update the scheduling settings 200 and re-allocate the unprocessed job 230.

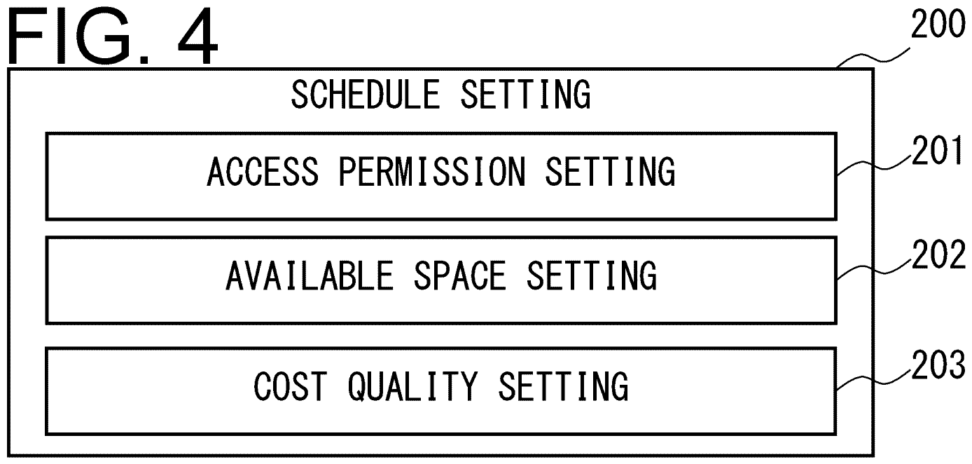

The learning unit 110 learns the model 220 that represents the relationship between the settings of jobs 230 and the processing results and the actual performance of component apparatuses based on characteristic data 300 (FIG. 4), the processing result data 310, and processing performance data 320 stored in the DB 210.

In the present embodiment, the learning unit 110 may learn the model 220 by itself for information in DB 210 that is set to be inaccessible. The learning unit 110 may share the learned model 220 with the other print servers.

Further, the learning unit 110 may learn to optimize scheduling based on the instruction information 420 and the delivery date achievement information 317 in the model 220. Furthermore, the learning unit 110 may learn the relationship between the order information 350 and the schedule setting 200 in the model 220.

In the present embodiment, the learning unit 110 can also learn weather information 340 into the model 220.

Furthermore, the learning unit 110 can also learn into the model 220 the relationship between the operator (hereinafter simply referred to as “operator”) who performs the work of allocating jobs 230 and issuing execution instructions and work performance information 330.

In addition, the learning unit 110 may also learn the relationship between the schedule setting 200 and the order information 350 into the model 220.

The processing management unit 120 allocates the unprocessed job 230 to the available space setting 202 of the schedule setting 200 based on the output result of the model 220 for the unprocessed job 230 according to the instruction information 420 including the condition to be prioritized. On this basis, the processing management unit 120 can transmit the unprocessed job 230 to the other print server to request processing. Alternatively, if the processing management unit 120 is to process the unprocessed job 230 on the own print server, it causes the corresponding component apparatus to process the unprocessed job 230.

Further, the processing management unit 120 outputs information on the setting and scheduling allocation of the unprocessed job 230 for processing at the optimal cost by the model 220 in accordance with the instruction information 420 based on the processing instruction, which includes the condition to be prioritized. This output is executed by the learned model 220 learned by the learning unit 110.

In this case, the processing management unit 120 can calculate the expected profit after scheduling by using the model 220 and make a proposal to increase the profit by changing the instruction information 420.

Furthermore, the processing management unit 120 can update the schedule setting 200 and re-allocate the unprocessed job 230 when the set value of lower limit is changed because there is a possibility that the expected profit will be less than the set value of lower limit.

Alternatively, the processing management unit 120 can also output information on the setting and scheduling allocation of the unprocessed jobs 230 for processing at the optimal quality by the model 220 in accordance with the instruction information 420 that includes the condition to be prioritized. This output is performed by the learned model 220 that has been learned by the learning unit 110.

In this case, the processing management unit 120 can calculate the expected quality value after scheduling by using the model 220 and make a proposal to improve quality by changing the instruction information 420.

Furthermore, the processing management unit 120 can update the schedule setting 200 and re-allocate the unprocessed job 230 when the set value of lower limit is changed because there is a possibility that the expected quality value will be less than or equal to the set value of lower limit.

In the present embodiment, the processing management unit 120 also uses the model 220 to output information on the possibility of handling sudden orders based on the user's processing instructions from the management terminal 6.

The processing management unit 120 may also output information on the allocation of the operators.

Furthermore, the processing management unit 120 may transmit the job 230 itself, the data processed by the job 230, and the processing status notification and completion notification to the management terminal 6. On this basis, the processing management unit 120 may manage the processing of the job 230 according to the settings of the dedicated application.

The schedule setting 200 is setting information that indicates the schedule status for the execution of each job 230.

The details of the schedule setting 200 are described later.

The DB 210 is a database that stores the characteristic data 300 and processing result data 310 for processed jobs 230, processing performance data 320 for component apparatuses, and other data.

In the present embodiment, the DB 210 is set to be individually accessible or inaccessible for each piece of information.

The details of the DB 210 are also described later.

The model 220 is model data such as AI, or the like. In the present embodiment, the model 220 may include a model that represents the relationship between the settings of the job 230 and the processing results and the actual performance of the component apparatus.

For this reason, the characteristics, processing results, and processing performance of the processed the job 230 are learned (trained) in the model 220. In the present embodiment, the model 220 may also learn the relationship between the operator and the work performance information 330. In addition, the weather information 340 may also be added to the model 220 and learned.

Furthermore, the model 220 may also learn the relationship between the forecast and actual results of scheduling when the job 230 is allocated in the available space setting 202 of the schedule setting 200.

In addition, the model 220 may also learn the relationship between the schedule setting 200 and the order information 350.

Among these, the model 220 may be a single model or a compound model in which each model is connected. The model 220 is also possible to use Convolution Neural Network (CNN), Gaussian Mixture Model (GMM), Transformer, k-Nearest Neighbor (kNN), Bayesian network, kernel machine, decision tree, and various other machine learning and statistical models.

The job 230 is data that summarizes various data used in production printing. The job 230 may be described in, for example, Job Description Format (JDF) and/or Job Messaging Format (JMF).

The details of the job 230 are also described later. (Details of Schedule setting 200)

Then, as refer to FIG. 4, the details of the schedule setting 200 are explained.

In the present embodiment, the schedule setting 200 includes an access permission settings 201, an available space setting 202, and a cost quality setting 203.

The access permission setting 201 is information on access permissions for individual information. Access permission setting 201 may be set for each ID (identification) of each print server 1 of the industrial printing system X and for each piece of information. Furthermore, access permission setting 201 may be set for various other criteria, such as the country in which each print server 1 is located, network addresses, groups, and others.

The available space setting 202 is a database that stores, for each ID of the print server 1 and component apparatus, information on the processing schedule (allocated or assigned) or available (free space) of a job 230, a processing status of the job 230, operating status, shipping records, or the like, in chronological order. Among these information, the shipping record may be information on the physical shipping of the printed matter after printing. The shipping record may include information such as the time of completion of printing, shipping time, receipt time, and the like. Furthermore, in the present embodiment, the available space setting 202 may also include information on the ID of the operator who is assigned to process the allocated job 230 in addition to the processing schedule.

The cost quality setting 203 is a setting for cost and quality. The cost quality setting 203 may be set for each print server 1, printing processing date and time, component apparatus, and available space. Specifically, the cost quality setting 203 can set different costs and expected quality values for each available space in the available space setting 202. For example, it is possible to set different costs and expected quality values for normal working days and working days for unexpected jobs 230. The expected quality value can include, for example, expected values for defective areas and color differences (ΔE), expected values for inspection failures, and expected values for returns. Specifically, a score may be set on a logarithmic scale, or the like, with 100% being the highest value, based on the percentage of waste, defective areas and color differences (ΔE), and other defect rates and expected values, or the like, after inspection. In such example, 100% may be the highest quality.

Furthermore, the cost quality setting 203 can also be used to set different costs according to the number of requests for the job 230, the number of the job 230 that can be accepted for processing, or the like.

### Details of DB 210

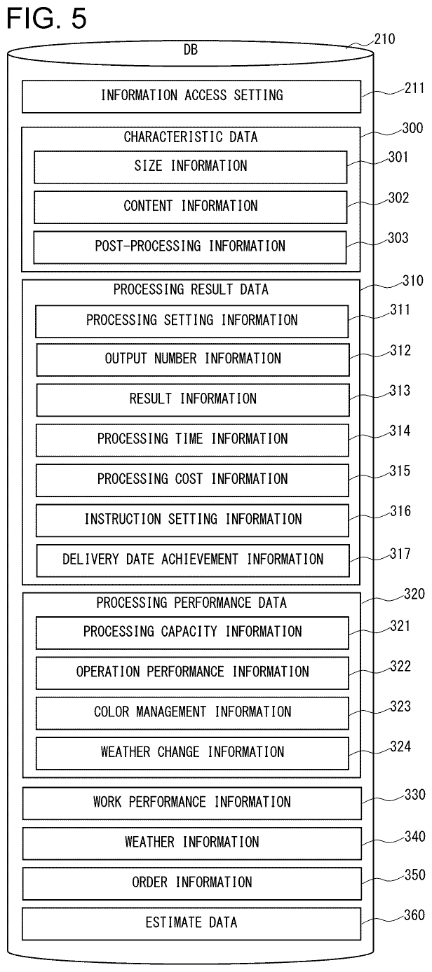

Then, as refer to FIG. 5, the details of the DB 210 are explained.

In the present embodiment, the DB 210 includes information access setting 211, characteristic data 300, processing result data 310, processing performance data 320, work performance information 330, weather information 340, order information 350, and estimate data 360.

The information access setting 211 is data that sets whether each piece of information can be accessed or not individually for each ID of each print server 1 in the industrial printing system X. This information access setting 211 may also be set to allow access based on various criteria in the same way as the access permission setting 201 in the schedule setting 200.

The characteristic data 300 is detailed processing data that shows the characteristics of a job 230.

In the present embodiment, the characteristic data 300 may be data that can analyze the characteristics of the job 230. Specifically, the characteristic data 300 is stored regarding the characteristics of the job 230 such as a monochrome printing job for a large number of pages but not a large data size, a color printing job for a small number of pages but a large data size that includes photographs by using special colors, or the like.

The processing result data 310 is data that summarizes various information, such as the processing time and cost, or the like, when actually processing job 230, and the processing results of the processing of job 230, such as the print quality, or the like. In the present embodiment, the processing result data 310 stores data that can be analyzed for each characteristic of the job 230.

The processing performance data 320 is data on the performance of printing and post-processing by component apparatuses. In the present embodiment, the processing performance data 320 stores data that can be used to analyze the processing capabilities of each component apparatus for the job 230.

The details of the characteristic data 300, the processing result data 310, and the processing performance data 320 are described later.

The work performance information 330 is information on the work performance of operators. In the present embodiment, the work performance information 330 includes the ID of each operator's account and work data. This work data may include the number of work jobs and work time for each characteristic of job 230 as data related to the work cost of the operator. Furthermore, the work data may include data related to the print quality of the operator. The data related to the work cost and the print quality may include information on the error and performance of the processing. The information on error and performance of the processing includes the error content and the number of times it occurred, as well as the date and time of occurrence. Furthermore, the work performance information 330 may include information on the inspection OK or no good (NG) results and their content, or the like, for each characteristic of the job 230, which includes defect locations and color difference (ΔE) information as the actual results of the print inspection.

The weather information 340 is information on the weather when the job 230 has been processed. This information on the weather may include temperature and humidity values, or the like, when the job 230 has been processed. This temperature and humidity values may include values of temperature and humidity obtained from sensors installed at the location where the component apparatus is installed, or values of temperature and humidity obtained from sensors installed in the component apparatus, values of temperature and humidity obtained from a weather information server, and the like. Furthermore, the weather information 340 may include information on short-term or long-term forecasted weather.

The order information 350 is information on orders on the calendar.

In the present embodiment, the order information 350 may be information that can be analyzed for busy periods for orders, trends in sudden orders, or the like. For this reason, the order information 350 may be information on the forecast and actual results of orders on the calendar. Further, the order information 350 may include performance information when processing an unexpected order. Furthermore, the order information 350 may include processing instructions by the user, such as delivery date and priority. This processing instruction may correspond to the instruction information 420 as described later.

In addition, in the present embodiment, the order information 350 may include information on a result of scheduling (hereinafter referred to as a “scheduling result”). The scheduling result is data indicating the results of scheduling by the processing management unit 120. The scheduling result may indicate, for example, the time at which the job 230 has been allocated based on the schedule setting 200, the processing time and average processing completion time of the allocated job 230, the overall cost including the amount of consumables and expenses, the quality results, or the like.

The estimate data 360 may be data indicating the estimate for processing the job 230.

In the present embodiment, the estimate data 360 may include the expected profit and the expected quality value after scheduling set to the scheduling 200. The expected profit may be based on the estimated time for printing and post-processing, the estimated amount of consumables such as ink and paper, and other costs. The expected quality values may include, as described above, expected values for defects and color differences (ΔE) in the output results of each job 230, expected values for inspection failures, expected values for returns, or the like.

Here, the details of the characteristic data 300 are explained.

In the present embodiment, the characteristic data 300 includes size information 301, content information 302, and post-processing information 303.

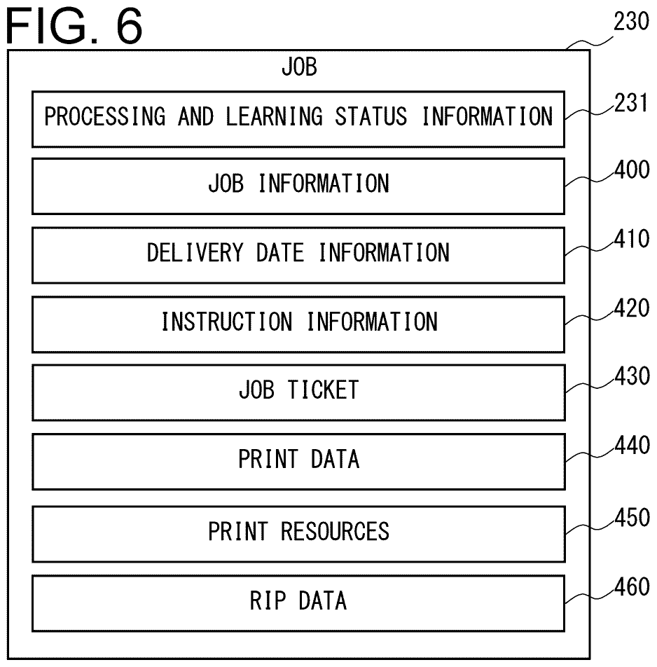

The size information 301 is information about the size characteristics of the job 230 calculated from the job information 400 (FIG. 6), print data 440, and print resources 450, or the like, in the job 230. For example, the size information 301 includes information such as data size, number of pages, paper size, DPI (dots per inch), and the like.

The content information 302 is information about the content obtained from the job 230. For example, the content information 302 includes preflight information, profile information, font information, image data information, or the like.

The post-processing information 303 is information about the post-processing jobs 230 and processing after printing of the printing jobs 230.

Then, the details of the processing result data 310 is explained.

In the present embodiment, the processing result data 310 includes processing setting information 311, output number information 312, result information 313, processing time information 314, processing cost information 315, instruction setting information 316, and delivery date achievement information 317.

The processing setting information 311 sets the main information for processing settings for each component apparatus, such as imposition, ganging, paper expansion/contraction correction settings, and post-processing. In addition, the processing setting information 311 sets an ID that identifies the component apparatus that has been processed for each job 230, or the like, as information on processed component apparatus.

The output number information 312 is information on the number of printed output sheets and copies when the job 230 is processed. For example, the output number information 312 may be set to include the number of color sheets, the number of monochrome sheets, the number of blank sheets, the number of copies, and the like.

The result information 313 is information indicating the results of printing and post-processing. Specifically, the result information 313 includes information value indicating whether or not a success, error, or waste occurred, and the like. Further, the result information 313 may include information such as printing paper errors, defective areas, color differences (ΔE), and expected returns due to these as inspection results. As such, the result information 313 may be related to the expected quality value.

The processing time information 314 is information on the processing time taken for printing and post-processing of the job 230.

The processing cost information 315 is information on the printing cost including the ink used, paper used, cost of using printing apparatus 2, and operator cost, or the like, taken for processing the job 230.

Further, the processing cost information 315 may also include profit information for the job 230 such as sales per the job 230 and profit value obtained by subtracting the printing cost from the order amount.

The instruction setting information 316 includes information on the user's processing instructions for the job 230 and information on the instructions given by the operator. These instructions may include information on the condition to be prioritized such as cost priority, quality priority, or the like. These conditions may be the same as the conditions in the instruction information 420 for the job 230, which is described later. These conditions can be set by the user by using the GUI on the management terminal 6.

The delivery date achievement information 317 is information on the estimated and actual processing of the job 230. In other words, the delivery date achievement information 317 is information on the actual processing schedule compared with the planned processing schedule.

In the present embodiment, the delivery date achievement information 317 includes information on the processing date and time of the job 230, the difference between the date and time set in delivery date information 410 (FIG. 6) for the job 230 and the completion date and time, and information on how much time has been available, or the like. Furthermore, the delivery date achievement information 317 includes information on whether the job 230 has been a planned job in advance or a job of a sudden order, or the like. This makes it possible to accumulate data that can be used to analyze the degree of on-time delivery for each characteristic of the job 230.

Then, the details of the processing performance data 320 is explained.

In the present embodiment, the processing performance data 320 includes processing capacity information 321, operation performance information 322, color management information 323, and weather change information 324.

The processing capacity information 321 is performance information on the number of processing jobs and processing time for each characteristic of the job 230. This performance information includes other costs and other information on the processing of the job 230, or the like. Further, the processing capacity information 321 includes information that can be analyzed for processing results and processing results for each characteristic of the job 230.

In the present embodiment, the processing capacity information 321 also includes information on the error and performance of the component apparatus. This error and performance information includes performance information such as the error details, the number of times it occurred, the date and time it occurred, the time required to recover from the error, or the like.

Furthermore, the processing capacity information 321 also includes information on performance of inspection results. This information on performance of inspection results includes the OK/NG results of the inspection for each characteristic of the job 230, color difference (ΔE) information, or the like.

Furthermore, the processing capacity information 321 includes performance information on set change work of the component apparatus. This performance information on set change work is the performance information on the work of changing the settings of the paper (recording paper) and other components.

Furthermore, the processing capacity information 321 may also include performance information on the jobs 230 processed by batch processing, which processes the same processing together, ganging processing, which processes the same print-processable jobs 230 together on a single sheet of recording paper, and the like.

The operation performance information 322 is information on the operation performance of the component apparatus. In the present embodiment, the operation performance information 322 accumulates data that can be used to analyze the operation rate of the component apparatus based on the operation performance to the schedule.

In the present embodiment, the operation performance information 322 may be information on the operation performance of the component apparatus related to the printing cost and printing quality. More specifically, the operation performance information 322 may include information on the operation period and time of the component apparatus.

Further, the operation performance information 322 may include information on the maintenance time, maintenance content, work date and time as the maintenance performance information of the component apparatus.

Furthermore, the operation performance information 322 may include information on the operating time, non-operating time, and idle time of the component apparatus.

The color management information 323 is information on the color management processing record of the component apparatus. In the present embodiment, it includes information on the color management operation and color fluctuation status when scheduling and processing the job 230. This allows data to be accumulated that can be used to analyze how often color management should be performed and color correction should be performed.

In the present embodiment, the color management information 323 includes performance information on color management operation. This information includes information on the content of the color management operation, the date and time of the work, the elapsed time since the previous color management operation, the number of processed jobs, and the content of the processed job 230. This information on the content of the processed job 230 may also include information such as the number of printed pages and ink consumption.

The color management information 323 may include information on the status of color variation with respect to a threshold value. This information on the status of color variation may include information indicating the status of color variation with respect to the threshold value.

The weather change information 324 includes information on the weather of component apparatuses in addition to the temperature, humidity, or the like, when processed in the same way as the weather information 340 as described above.

Specifically, the weather change information 324 may include information set to correct paper shrinkage caused by the weather, information on the printing results due to changes in the ink condition caused by the weather, or the like.

### Details of the Job 230

Then, as refer to FIG. 6 the details of the job 230 are explained.

In the present embodiment, the data used mainly in rasterization, printing, and post-processing in the job 230 is explained.

For example, the job 230 includes processing and learning status information 231, job information 400, delivery date information 410, instruction information 420, job ticket 430, print data 440, and print resources 450 (hereinafter, these are also referred to as “data contents.”) In addition, the job 230 may include RIP data 460 as the other data contents.

The processing and learning status information 231 indicates the processing and learning status of the relevant job 230.

In the present embodiment, the processing and learning status information 231 includes information on whether the job 230 is a processed job that has already been processed or an unprocessed job.

Further, the processing and learning status information 231 may also record information such as a flag indicating whether the relevant job 230 has already been used for training the model 220 or not and the ID of the print server 1 that has performed the training if the relevant job 230 has been processed.

Furthermore, the processing and learning status information 231 may also include the information of weather, which is similar to weather information 340, at the time of processing, schedule change information, information on processing changes when actually processed, other information, and the like.

The job information 400 is data that includes attributes specified in the printing process(hereinafter referred to as “specified attributes.”) As specified attributes, job type, job name, project (order) name, assignment of printing apparatus 2 or post-processing apparatus 3, number of copies and whether or not collating is required, whether or not recording is required, number of milli-meter of trimming, printing direction, printing status, priority, or the like, are set. Among these, the job types include a job that perform rasterization processing (a rasterization job), a job that perform printing processing (a printing job), and a job that perform post-processing (a post-processing job).

The delivery date information 410 is information on the delivery date of job 230. The delivery information can be set to one or more types of delivery time information, such as the delivery date and time, and the desired completion date and time.

Among these, the due date and time is the absolute due date and time specified by the user or upstream system that have to be completed. The desired completion date and time is the date and time that the user wishes to complete the job 230. This desired completion date and time may correspond to the threshold setting as described later.

Further, the delivery date information 410 may also include the information on the estimated time of completion output at the time of scheduling.

The instruction information 420 is information about the user's processing instructions, which includes the condition to be prioritized for the job 230. Specifically, the instruction information 420 may include a priority setting for whether to prioritize the delivery date, the operating rate, or the number of processing jobs.

Among these, the instruction to prioritize the delivery date is prioritizing the delivery date in the delivery date information 410 and performing processing with as much leeway as possible with regard to the delivery date. The instruction to prioritize the operating rate is an instruction that maximize the operating rate within a specific period, for example, the operating rate per day, or the like. The instruction to prioritize the number of processing jobs is an instruction that maximize the number of processing jobs within a specific period, for example, the number of processing jobs per day, or the like.

In the present embodiment, the instruction information 420 includes a set value of lower limit for the expected profit and the expected quality value. The set values of lower limit for the expected profit and the set value of lower limit for the expected quality value can be set by the user on the GUI of the management terminal 6.

Further, the instruction information 420 may also include settings for priorities regarding the output of the job 230, such as the type of component apparatus, paper type, post-processing type at the time of output, and the like, for of the job 230. Furthermore, in the present embodiment, the instruction information 420 may also include reservation information for specifying the print server 1, printing apparatus 2, and post-processing apparatus 3 to be processed.

The job ticket 430 is setting data that includes print instruction attributes for requesting a job 230. The job ticket 430 includes necessary settings in the printing process and post-processing process such as lower settings in the workflow, which are order settings, for example, color mode specifications, imposition specifications, paper specifications, binding specifications, and the like.

Further, the job ticket 430 may also be described in JDF and/or JMF.

The print data 440 is data of a printing manuscript whose design is set according to the order. The print data 440 may be, for example, electronic document data such as portable document format (PDF), post script (PS) data, other vector data, data in a format for submitting a manuscript, other raster image data, or the like.

The print resources 450 are various resource information necessary for printing instructions such as color mode and font. These various resources may be referenced by the model 220.

The other resource data necessary for printing may also be included in the print resources 450.

The RIP data 460 is data such as PDF, or the like, which includes image data that has been rasterized based on the job ticket 430. This image data may be, for example, TIFF or other bitmap data. In addition, the image data may be lossless or irreversibly compressed.

In addition, in the present embodiment, the DB 210 may include information on the processing capacity and status of each component apparatus. This information on the processing capacity of the component apparatus may be information on the capacity that can be processed in rasterization, printing, and post-processing, processing time, and output speed (hereinafter referred to as “throughput.”) The status information may also include information on the paper and consumables that have been set, as well as information indicating the operational status and maintenance status, or the like.

Further, in the present embodiment, the DB 210 may temporarily store the user's processing instructions themselves via the management terminal 6. These user processing instructions may be set in the instruction setting information 316 of the processing result data 310.

Further, the DB 210 may also include alternative settings for capabilities and settings that can be replaced. This alternative setting is set to indicate, for example, whether color mode and fonts, or the like, can be replaced or not. Furthermore, the alternative setting may also include settings such as the extent to which replacement is allowed if replacement is possible, or the like.

In the present embodiment, this alternative setting may be set by the user by using the dedicated application.

Here, the controller 10 of the print server 1 is made to function as the schedule management unit 100, the learning unit 110, and the processing management unit 120 by executing the control program stored in the storage 19.

In addition, the above-mentioned parts of the print server 1 become hardware resources that execute the processing management method of the present disclosure.

In addition, some or any combination of the above functional configurations may be configured in hardware or circuitry by using ICs, programmable logic, Field-Programmable Gate Arrays (FPGAs), or the like.

### Job Order Process by Print Server 1

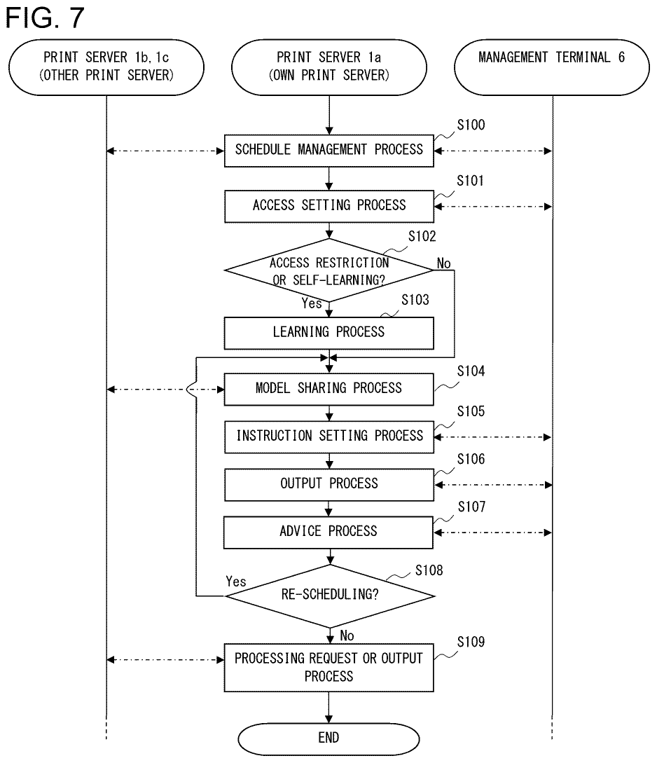

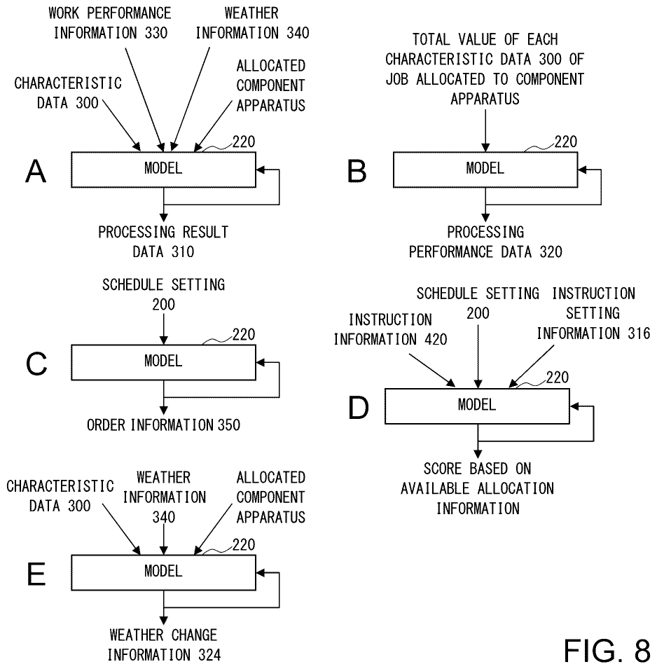

Next, as refer to FIGS. 7 to 8, a job order process by the print server 1 according to the embodiment of the present disclosure is explained.

In the job order process according to the present embodiment, firstly, access to the other print servers is permitted or restricted. On this basis, the characteristic data 300 and the processing result data 310 of the processed job 230 and the processing performance data 320 of the component apparatus are stored. Then, based on the characteristic data 300, the processing result data 310, and the processing performance data 320 stored in the DB 210, the model 220 that optimally allocates jobs 230 to component apparatuses is learned. In response to the instruction information 420 that includes the condition to be prioritized, the unprocessed job 230 is allocated to the available space setting 202 of the schedule setting 200 based on the output result of the model 220 for the unprocessed job 230, and it is processed by the other print server or the own print server.

In the job order process according to the present embodiment, as an example, a case where the print server 1a of the printing line (site) “A” is explained the own print server (processing request side). In this processing, an example where the controller 10 of the print server 1a mainly executes the program stored in the storage 19 in cooperation with each unit using hardware resources is described.

Below, with referring to the flowchart in FIG. 7, the details of the job order process step by step is explained.

### Step S100

Firstly, the schedule management unit 100 performs a schedule management process.

The schedule management unit 100 shares the processing schedule 200 for the jobs 230 of the component apparatuses between the print servers 1 in the industrial printing system X.

In the present embodiment, the schedule setting 200 is shared by all the print servers 1 of the industrial printing system X, which are connected in a peer-to-peer configuration, and the schedule for processing the jobs 230 allocated to the printing apparatuses 2 and post-processing apparatuses 3 (component apparatuses) managed by each print server 1 of the industrial printing system X is shared by all the print servers 1 of the industrial printing system X. For this purpose, the schedule management unit 100 is connected with each print server 1 and determines the processing status and completion status of the jobs 230. The statuses are then reflected in the schedule setting 200 and updated in real time. As a result, the schedule management unit 100 is able to manage the available space settings 202 of the schedule setting 200 in a unified manner.

Furthermore, the schedule management unit 100 is able to acquire information on the processing capacity and status of the connected component apparatuses from each print server 1 as appropriate and set them in the schedule setting 200.

Thus, the schedule management unit 100 sets the processed job 230 to be already processed to the processing and learning status information 231. The schedule management unit 100 then stores various information, which includes information on this job 230, information on the allocated component apparatus, and information on the availability of the schedule, in the DB 210.

Furthermore, the schedule management unit 100 can store various data on the processing of the job 230 in the DB 210.

Furthermore, this update may be performed by the schedule management unit 100 of the print server 1 (the own print server,) which has received the processing status after notifying the other print servers. The schedule management unit 100 shares the updated schedule setting 200 with the other print servers.

### Step S101

Then, the schedule management unit 100 performs the access setting process.

In the present embodiment, the schedule setting 200 and the information stored in each component apparatus are shared between the print servers 1 of the industrial printing system X in a peer-to-peer manner.

Thus, the schedule management unit 100 acquires the schedule setting 200 and DB 210 access setting instructions by the user via the Graphical User Interface (GUI) of the dedicated application on the management terminal 6.

Based on this setting instruction, the schedule management unit 100 sets the schedule setting 200 to be accessible or inaccessible for each ID of the other print servers. At this time, the schedule management unit 100 may send a command to the other print servers to instruct them to set the schedule setting 200 of the other print servers to be accessible for the print server that is the source of the request for processing.

Further, the schedule management unit 100 can also restrict access to specific items of the schedule setting 200 in response to access from a specific print server 1. For example, the schedule management unit 100 can prevent the specific print server 1 from accessing the schedule setting 200 for a specific date and time and prevent it from being requested to perform distributed processing of the job 230 on that date and time.

Specifically, the schedule management unit 100 can set the access permission setting 201 to restrict access from the other print servers for a specific period and/or a specific component apparatus in the schedule setting 200. The schedule management unit 100 then manages to prevent the jobs 230 from being allocated for the restricted period and/or the specific component apparatus set in the access permission setting 201.

Furthermore, the scheduling management unit 100 can also restrict access to specific information in the DB 210 for access from a specific print server 1. For example, it is possible to set it so that information about the specific job 230 cannot be accessed, or the like. In addition, the scheduling management unit 100 may send a command to the other print server to instruct it to set access to information stored in the DB 210 of the other print server to be possible.

Specifically, the schedule management unit 100 can set whether or not each piece of information can be accessed individually for each ID of the print server 1 in the information access setting 211 of the DB 210 based on the setting instructions.

Furthermore, the schedule management unit 100 can also set the cost quality setting 203.

The schedule management unit 100 can set different costs depending on the printing processing date and time, or the like, in the cost quality settings 203. For example, the schedule management unit 100 can refer to the order information 350 and set the cost to be different for normal work dates and times and work dates and times for an unscheduled job. In this case, the schedule management unit 100 can be set to make changes such as changing the cost of the work time for the unscheduled job 230 from the prescribed premium cost to a lower cost after it is confirmed that no unscheduled jobs 230 is to be occurred. This change can be made by the schedule management unit 100 by using specific heuristics or by user instruction.

Furthermore, the schedule management unit 100 can set different costs, the number of jobs 230 that can be accepted, or the like, in the cost quality setting 203 for each print server 1, depending on the number of jobs 230 that are accepted. Alternatively, the schedule management unit 100 can set the cost according to the total number of jobs 230 requested within a specific period, and it is also possible to set that jobs 230 that exceed this total number may not be accepted.

Furthermore, because the schedule setting 200 are shared as described above, the cost conditions may be shared among the print servers 1 by the cost quality settings 203.

### Step S102

Here, for learning, the learning unit 110 determines whether the information in the DB 210 can be accessed or restricted, or learning is to be performed on the own print server.

In this case, if the learning unit 110 can access the information in the DB 210 without restriction and learning is not to be performed on the own print server at this time, the learning unit 110 determines “Yes.” Otherwise, the learning unit 110 determines “No” if access to specific information in the DB 210 is restricted for access from a specific print server 1. That means, if there is information that has been set as inaccessible from the others, the learning unit 110 determines “No.” Alternatively, the own print server is set to perform learning according to a rule such as a specific order, randomly set, or the like, and if the model 220 is not being learned on the other print server, the learning unit 110 determines “Yes.” In other cases, the learning unit 110 determines “No.”

In the case of Yes, the learning unit 110 advances the process to step S103.

In the case of No, the learning unit 110 advances the process to step S104.

### Step S103

When learning on the own print server, the learning unit 110 performs the learning process in the own print server.

In the present embodiment, the learning unit 110 acquires various information from not only the own print server but also the other print server as data for learning (training) of the model 220, such as AI, or the like, and stores it in the DB 210. Similarly, the other print server can also acquire information on the own print server stored in the DB 210 and synchronize the DB 210 to a certain extent.

In this process, the learning unit 110 refers to the DB 210 of the own print server and selects those that have been processed in the processing and learning status information 231 of the job 230, is accessible by the own print server, and have not been learned. Then, the learning unit 110 learns the model 220 based on data such as the characteristic data 300, the processing result data 310 for each of the job 230, the processing performance data 320 for component apparatuses, the work performance information 330, the weather information 340, and the order information 350. In this case, the learning unit 110 sends a message to the other print servers to indicate that it is currently learning. In addition, if there is information that has been set to be inaccessible by the other print server, the learning unit 110 learns about this information by itself.

In the present embodiment, the learning unit 110 can use various machine learning (ML) methods, and in particular, it can use the optimal method for each type of model 220. For example, it can use supervised learning, such as the backpropagation (BP) or EM algorithm, unsupervised learning, reinforcement learning, statistical estimation, or the like.

As refer to FIG. 8, a specific example of this learning process is explained.

In “A,” the learning unit 110 inputs the characteristic data 300, the specifications of the allocated component apparatus, the work performance information 330, and the weather information 340 for each processed job 230, and it learns a model 220 such that each piece of information in the processing result data 310 is similarly output by using these data. In other words, the processing result data 310 can be used as training data. Thus, the learning unit 110 learns a model 220 that shows the relationship between the job 230 and the processing result. As a result, it is possible to learn the model 220 that outputs the cost and/or quality when a job 230 is allocated.

In “B,” the learning unit 110 also learns a model 220 such that, for each component apparatus, the total of the characteristic data 300 of all the processed jobs 230 that have been allocated is input and the information of each of the processing performance data 320 is similarly output. In other words, it is possible to use the processing performance data 320 as training data. As a result, it is possible to learn a model 220 that shows the results for each characteristic of a job 230 for a specific component apparatus.

In “C,” in addition, the learning unit 110 inputs the schedule setting 200 and also learns a model 220 in which the busy periods of orders or trends in sudden orders are output in the same way as the order information 350. In other words, the order information 350 may be used as the teacher data in this model 220. This makes it possible to learn a model 220 that shows the relationship between the schedule setting 200 and the order information 350.

In “D,” the learning unit 110 also learns scheduling optimization based on the instruction information 420 and the delivery date achievement information 317. The learning unit 110 performs a simulation in which it allocates the processed jobs 230 to the schedule setting 200 based on the output of the above-mentioned learned models 220 when each job is allocated in various combinations. Thus, the learning unit 110 calculates the available space of the schedule setting 200 from the simulation, based on the delivery date achievement information 317, and uses this as a score to learn the model 220 so that the optimal allocation is achieved. For example, the score may be increased if the available space of the schedule setting 200 decreases, many jobs 230 are allocated in a short period of time, and the operating rate of each job increases. In such case, the printing quality may also be added to the score.

In “E,” in addition, the learning unit 110 can also learn a model 220 about the relationship between the weather and the correction by the weather by inputting the weather information 340, the characteristic data 300 of each job 230, and the specification of the allocated component apparatus, and by performing BP, or the like, with the weather change information 324 as the training data.

Here, the learning unit 110 may learn each individual model 220 for each piece of information output, or it may learn an integrated model 220. The same applies to other information. In addition, each value input may be normalized as appropriate, or it may be convolved as appropriate for input to the model 220.

Furthermore, the learning unit 110 may set the learned job 230 to “learned” in the processing and learning status information 231.

In addition, the learning unit 110 can also generate a model 220 that combines the processing capacity and state of the component apparatus.

Furthermore, the learning unit 110 can also present the state of the generated model 220 to the user via the GUI of the dedicated application of the management terminal 6.

### Step S104

Then, the learning unit 110 performs the model sharing process.

The learning unit 110 shares the learned model 220 with the other print servers. The learning unit 110 shares the learned model 220, which is the model learned by the own print server or the model learned by the other print server, with the other print servers in the entire industrial print system X. Specifically, for example, when the learning unit 110 has completed its own learning, it broadcasts that it wishes to share the completed learning allows the other print servers to access the learned model 220. Otherwise, when this broadcast is received in the own print server, the learning unit 110 acquires the learned model 220 from the other print server via peer-to-peer communication and stores it in the storage 19.

This makes it possible to use the models 220, which have been learned, in a distributed manner simultaneously within the industrial printing system X. In addition, although the information of the original data is reflected in the learned model 220, the original data itself is not shown to the others, so anonymity is maintained. (Step S105)

Then, the processing management unit 120 performs the instruction setting process.

The processing management unit 120 acquires unprocessed jobs 230 from the management terminal 6, the upstream inter-site management system of the industrial printing system X, the other terminal by using the user, a prepress apparatus, or the like, and sequentially stores them in the storage 19. The job 230 may be created by the management terminal 6 for a manuscript submitted by the submission terminal.

When acquiring the job 230, the processing management unit 120 may set the processing and learning status information 231 of the job 230 to indicate that it is an unprocessed job. Furthermore, the processing management unit 120 may acquire the characteristic data 300 of this unprocessed the job 230. Specifically, it may acquire and store the size information 301, the content information 302, and the post-processing information 303 of the unprocessed the job 230.

At this point, the processing management unit 120 acquires the user's processing instructions for the unprocessed job 230 from the management terminal 6. These processing instructions are based on the instruction information 420, which the user indicates by using the GUI of the dedicated application.

Here, the processing management unit 120 may acquire the characteristics of the job 230 from the processing instructions. The processing management unit 120 may acquire instructions for information for the unprocessed job 230, information on the processing target component apparatus, order information 350, and information for the operator as the processing instructions.

In this case, as the information for the unprocessed job 230, the information for setting the characteristic data 300 can be obtained.

As the information for processing target component apparatus, it may be IDs or other specified information for specific component apparatuses or groups of apparatuses to which the job 230 is allocated.

As instructions in the order information 350, information for setting a delivery date and a priority can be acquired.

As information for the operator, information on instructions to the operator and information for setting the work performance information 330 may be acquired. Based on the information for instructions to the operator, the operators works the printing operation.

In addition, the processing management unit 120 may obtain data such as temperature and humidity from the weather information server, as well as the forecasted weather information 340, or the like.

Furthermore, the processing management unit 120 may store the above-mentioned user instructions in the instruction setting information 316 of the processing result data 310 of the DB 210. These instructions include the instructions and threshold settings for the condition to be prioritized as described below.

These instructions for the condition to be prioritized may be conditions for prioritizing quality, cost, delivery date, operating rate, or the number of processing jobs.

Among these, the condition to prioritize quality may be a condition that ensures printing quality as much as possible.

Alternatively, the condition to prioritize cost may be a condition that keeps costs down as much as possible.

Alternatively, the condition to prioritize delivery date may be a condition that processes jobs with as much time as possible to spare with respect to the delivery date.

Alternatively, the condition to prioritize operating rate may be a condition that maximizes the operating rate within a specific period, for example, the operating rate of a component apparatus per day.

Alternatively, the condition to prioritize the number of processing jobs may be a condition that maximizes the number of processing jobs within a specific period, for example, the number of processing jobs per day.

The processing management unit 120 can acquire these processing instructions and set them in the DB 210 and the unprocessed jobs 230.

Further, the setting of the condition to be prioritized may be able to set the conditions such as whether to apply, prioritize, or not apply the instruction information 420 in the job 230.

The threshold setting as mentioned above is a setting of condition for scheduling and starting execution of the job 230. In the present embodiment, the threshold setting includes a setting that indicates a threshold condition for the completion processing time of the job 230. Specifically, the threshold setting can set a threshold condition such that the earliest time for the estimated time of completion of processing for each job 230 exceeding the threshold date and time first, the latest time for the estimated time of completion of processing for each job 230 exceeding the threshold date and time first, or the like. This threshold date and time can be set by the user to a time period of several hours to several days. The threshold setting may be referred to when scheduling the actual allocation of the job 230.

In addition, the processing management unit 120 also outputs the possibility of processing sudden orders by using the model 220, which has learned the relationship between the above-mentioned schedule setting 200 and the order information 350.

In other words, it can present to the user on the GUI of the management terminal 6 the possibility of whether or not a job 230 can be allocated on the state of the schedule setting 200 in the first place.

If the user looks the possibility of allocation and gives instructions to allocate the job, the processing management unit 120 may include this in the user's processing instructions.

### Step S106

Then, the processing management unit 120 performs output process.

The processing management unit 120 uses the model 220 to output information on the scheduling allocation of the job 230 to be processed under the condition to be prioritized.

In the present embodiment, the processing management unit 120 not only schedules the unprocessed job 230, which is sent to the own print server for processing from the management terminal 6, or the like, but also schedules the job 230, which is requested for processing from the other print server.

Specifically, the processing management unit 120 refers to the data stored in the DB 210 for settings and scheduling allocation of the job 230 based on the condition to be prioritized, and it makes plurality of settings output from the model 220 to calculate the optimal combination of these settings. In other words, the processing management unit 120 generates an optimal schedule as needed. In this case, the processing management unit 120 may score the outputs from the model 220 by the processing results and processing performance to select the optimal combination. Alternatively, the processing management unit 120 may calculate this optimal combination by analyzing the learned model 220 itself.

Furthermore, the processing management unit 120 also refers to the cost quality settings 203, and while matching the conditions acquired from the requested print server 1, it performs scheduling by prioritizing quality, cost, delivery date, operation rate, or number of jobs to be processed according to the user instructions. At this time, the processing management unit 120 performs scheduling so that the expected profit and estimated quality are as high as possible.

Specifically, as information on the setting and scheduling allocation of the optimal combination of jobs 230, the processing management unit 120 outputs information on the optimal component apparatus in the own print server or the requested other print server, optimal operator, optimal processing settings, optimal processing date and time (time), and processing estimated time, or the like. This optimal processing settings include settings such as the optimal paper, imposition, paper expansion correction, post-processing, and color profile, or the like, for the component apparatus to be processed.

Further, the processing management unit 120 can also output a combination of unprocessed jobs 230 that can be processed ganging based on the condition to be prioritized.

Further, the processing management unit 120 can also output correction settings based on the model 220 of the relationship between the weather and the weather forecast. This correction setting includes an expansion and contraction setting for correcting paper shrinkage, a color profile setting for correcting ink condition, or the like.

Furthermore, the processing management unit 120 may calculate how many unexpected orders can be handled as expected information about unexpected orders. In this case, it may also indicate the time available for handling sudden orders for the own print server and the characteristics of the jobs 230 that can be handled.

On this basis, the processing management unit 120 outputs calculated information including the printing cost and expected quality for the optimal combination.

More specifically, for example, the processing management unit 120 may output the following information for processing one unprocessed job 230 at the lowest cost or highest quality:
Estimated Printing cost: $X,XXX
Expected profit: $X,XXX
Optimal component apparatus: Printing apparatus 2-1
Optimal operator: Operator-X
Optimal printing settings: Color profile (XYZ)
Optimal scheduling: 1/20 11:00-11:30

In this case, if the priority is cost, the processing management unit 120 outputs the above information such that the component apparatus that can be printed with the lowest cost and the lowest color difference (ΔE) criteria, the ID of operator with the lowest cost of operation, settings, allocation time, or the like.

Furthermore, the processing management unit 120 can output a combination that collects as many jobs 230 as possible for ganging and outputs them to lower the cost.

On the other hand, in the case of a condition to prioritize quality, the processing management unit 120 outputs information such as component apparatuses that can be printed with high color difference (ΔE) criteria, the ID of operator with a lot of experience in the characteristics of the corresponding job 230, printing settings, allocation time, or the like.

Furthermore, the processing management unit 120 can also output a combination that only collects jobs 230 that can be performed ganging with high printing quality.

Then, based on the output, the processing management unit 120 can also perform scheduling to allocate the job 230 to the available space setting 202 of the schedule setting 200 by using the set values of the conditions set by the user.

The processing management unit 120 can have the corresponding component apparatus process the job based on the allocation.

Here, when the processing management unit 120 allocates the job 230 to the schedule setting 200, it may calculate estimated processing completion time and delivery completion rate of the job 230 and set them in the delivery date information 410. This estimated processing completion time and delivery completion rate may be calculated based on the processing capacity and status information of the component apparatus allocated to the schedule setting 200. For example, the processing management unit 120 may calculate the estimated processing completion time based on the expected processing time at the allocated schedule setting 200. Further, the processing management unit 120 may set the calculated estimated processing completion time for the job 230 in the job 230 itself and the schedule setting 200. The processing management unit 120 may calculate the delivery completion rate based on this according to the order information 350. Furthermore, the processing management unit 120 may calculate the operating rate of each component apparatus and the estimated number of processing jobs within a specific period and record them in the operation performance information 322 and processing capacity information 321.

Here, the processing management unit 120 may output the above-mentioned information as follows:
Expected quality: No defects, registration error within X.X mm, color difference within XX
Estimated processing completion time, delivery completion rate: Estimated completion date and time is X/X X:X:X, estimated delivery completion rate XX %
Estimated component apparatus operating rate: XX %
Estimated number of processing jobs: XXX

More specifically, the processing management unit 120 may calculate the processing time for each job 230 based on the number of printed pages and the average throughput (Page Per Minutes) of the allocated component apparatus, or the like. Furthermore, the processing management unit 120 may also calculate other costs, such as the amount of consumables, in the similar manner.

Furthermore, in the case of allocating each job 230, if the delivery date and time of the delivery date information 410 is exceeded, the processing management unit 120 may present the job 230 itself as an error.

The processing management unit 120 stores these scheduling outputs as a scheduling result in the schedule setting 200. In the present embodiment, the processing management unit 120 sets this schedule result in the available space settings 202 and writes it in the cost quality settings 203.

At this point, the processing management unit 120 may send the scheduling result again to the dedicated application of the management terminal 6.

### Step S107

Then, the processing management unit 120 performs the advice process.

The processing management unit 120 generates the estimate data 360 by using the model 220 based on the scheduling result. At this time, the processing management unit 120 calculates the expected profit and the expected quality value and stores them in the estimate data 360. Then, the estimate data 360 may be sent to the management terminal 6.

The GUI of the dedicated application on the management terminal 6 can display the expected profit and the expected quality values, which includes the cost, processing time, amount of consumables, other costs, expected quality, or the like, of processing job 230 from the estimate data 360.

Then, the processing management unit 120 performs scheduling for a plurality of combinations to check whether the expected profit and the expected quality will be further improved by changing the instruction information 420. This makes it possible for the processing management unit 120 to present, via the GUI of the management terminal 6, a proposal to increase profit or improve quality by changing the instruction information 420.

As the proposal to increase profit, the processing management unit 120 can also make proposals to increase expected profit by changing the instruction information 420. For example, the processing management unit 120 may make proposals such as changing to cheaper paper that is as close as possible to the specified paper, changing to increase the number of copies to be printed in anticipation of additional orders, thereby reducing the printing cost, or the like. In such case, if there is no setting or scheduling that is above the lower limit of the expected profit, the processing management unit 120 may present information that will result in the closest possible profit, and it may indicate a proposal to satisfy the expected profit.

Further, as the proposal to improve quality, the processing management unit 120 can make proposals to improve quality by changing the instruction information 420. For example, the processing management unit 120 can make proposals such as changing to a higher quality paper than the specified paper, or changing to a profile that increases the amount of ink applied. In such case, if there is no setting or scheduling that is above the lower limit of the expected quality value, it is possible to indicate information that will result in the closest possible quality and to indicate a proposal for meeting the expected quality.

Here, the processing management unit 120 also provides advice even when the expected profit and expected quality are not achieved. Specifically, if there is a possibility that the expected profit will fall below the set value of lower limit due to the instruction information 420 by the user or the unprocessed job 230, the processing management unit 120 requests the user via the GUI of the management terminal 6 to instruct whether to change the set value of lower limit or to proceed with the processing as is. Similarly, if the expected quality value is likely to be less than the set value of lower limit, based on the instruction information 420, the processing management unit 120 asks the user whether to change the set value of lower limit or to process as is.

Further, the processing management unit 120 can indicate that the expected profit may be less than the set value of lower limit due to unexpected printing problems, such as a large number of printing errors or paper wastage. Also, if the color quality deteriorates due to similar printing problems, the processing management unit 120 can notify the user of this and propose readjustment by using color management.

Furthermore, the processing management unit 120 can also propose rescheduling of the job 230 scheduled in the schedule setting 200. In other words, it can indicate the existing scheduling and the rescheduling and present the impact of the change, so that either can be selected. Also, the processing management unit 120 can indicate schedule delays, or the like, associated with rescheduling.

For example, the processing management unit 120 can make a proposal to allocate a component apparatus of the print server 1 that can meet the target quality by rescheduling the job 230, which has already been scheduled.

Further, for example, the processing management unit 120 can make a proposal to indicate the points of the work, or the like, so that even an operator with low skills can meet the target quality if an operator with high skills cannot be assigned.

Specifically, for example, the processing management unit 120 may print the points of work that need to be checked such as paper settings, print settings, color management status, or the like, on a work instruction sheet and present it to the operator.

Also, the processing management unit 120 may be configured to send a command, or the like, to necessarily display a confirmation message when proceeding to the next operation on the print server 1 executing the job 230, and to prevent the user from proceeding further unless the “OK” button is pressed.

Furthermore, if there is a possibility of a delay in the delivery date of the job 230 that has been scheduled and already sent to the requesting side, the other print server sends the status notification of the delay to the own print server.

The processing management unit 120 of the own print server that has requested the job 230 acquires the status notification of the delay and presents the expected delay situation to the user via the GUI of the management terminal 6.

The processing management unit 120 of the own print server may also acquire instructions from the user regarding changes to the scheduling due to this delay as the instruction information 420.

This allows the user to check the scheduling results on the GUI and to give instructions regarding changes to the processing instructions themselves.

In addition, as explained below, the processing management unit 120 may perform rescheduling, and in that case, it may present the existing scheduling and the rescheduling and allow the user to select.

In the GUI, it also allows the user to instruct the model 220 to be trained, modified, selected, or the like, together with or separately from the scheduling instruction.

### Step S108

Then, the processing management unit 120 determines whether or not to perform rescheduling.

The processing management unit 120 determines “Yes” if the lower limit of the expected profit or the expected quality value is changed according to the processing instructions by the user. Also, if the status notification of the delay as described above is obtained or if the user instructs rescheduling, the processing management unit 120 determines “Yes.” In other cases, the processing management unit 120 determines that rescheduling is not necessary because processing is performed as is and determines “No.”

In the case of Yes, the processing management unit 120 returns the process to step S104, updates the model 220 with the other print server, and then performs rescheduling by allocating the unprocessed job 230 to the schedule 200 again.

In the case of No, the processing management unit 120 advances the process to step S109.

### Step S109

If the processing is to be carried out without changing the scheduling, the processing management unit 120 performs a processing request or output process.

The processing management unit 120 processes the job 230 on the own print server or sends the job 230 to the other print server to request processing as depended on the schedule setting 200. Specifically, the processing management unit 120 instructs the print server 1, the printing apparatus 2, and the post-processing apparatus 3 to process the job 230, which is set at the processing date and time in the schedule setting 200.

At this time, when processing the job 230 on the own print server, the processing management unit 120 processes the job 230 itself on the connected printing apparatus 2 or post-processing apparatus 3.

On the other hand, when the processing management unit 120 requests processing from the other print server, it sends the job 230 to the other print server and makes each component apparatus process the job 230. As a result, rasterization processing, printing processing, and post-processing of the unprocessed job 230 are executed at each of the set sites.

In addition, the processing management unit 120 may instruct print servers 1 between sites to transfer the job 230. When transferring the job, the processing management unit 120 may request that the job 230 be encrypted and sent to the other print server 1.

Furthermore, before and after this processing request and actual processing, the processing management unit 120 sends and receives processing status notifications and completion notifications for the job 230 between the corresponding print servers 1. In other words, the processing management unit 120 can manage processing status and completion of processing between the own print server and the other print servers. These notifications can also be broadcasted and shared between the print servers 1. This makes it possible to share the processing status of the job 230 between the print servers 1. Furthermore, the processing management unit 120 may send processing status notifications and completion notifications for the job 230 to the management terminal 6.

Further, the processing management unit 120 may also perform repeated scheduling and optimally allocate the job 230 when there is available space.

This completes the job order process according to the embodiment of the present disclosure.

As configured As configured in this way, the following effects are obtained.

In a typical production printing system, digital printing has the advantage of being able to print a wide variety of printing, such as personalized printing, in small lots. On the other hand, digital printing has a higher cost than offset printing.

Here, in production printing, in order to efficiently process a large number of printing jobs, printing has carried out in a distributed manner by using plurality of printers. However, with regard to this schedule, the printing processing schedule for the order jobs for the following week or month is made in advance and printing work is carried out. The schedule is often made in a personalized manner based on the experience of the operator and estimates and judgments.

In contrast, the industrial printing system X according to the present embodiment is an industrial printing system that performs production printing having a plurality of print servers 1 for distributed processing of a plurality of jobs 230, and each of the plurality of print servers 1 includes: a schedule management unit 100 that manages the schedule setting 200 of processing a job 230 of a component apparatus; a DB 210 that stores characteristic data 300 and processing result data 310 for processed jobs 230 and processing performance data 320 for the component apparatus; a learning unit 110 that learns a model 220 for optimally allocating jobs 230 to the component apparatus based on the characteristic data 300, the processing result data 310, and the processing performance data 320 stored in the DB 210; and a processing management unit 120 that allocates an unprocessed job 230 to an available space setting 202 in the schedule setting 200 based on output result of the model 220 for the unprocessed job 230 in accordance with instruction information 420 including condition to be prioritized, causes corresponding component apparatus to process the unprocessed job 230, or transmits the unprocessed job 230 to the other print server and requests processing of the unprocessed job 230.

As configured As configured in this way, in an industrial printing system that can be distributed in a peer-to-peer manner, the scheduling allocation, which has been a task that required a high level of skill, can be automated in a skill-free manner by training a model 220 such as AI, or the like. In other words, by using AI, or the like, with the information required for scheduling, an optimal schedule for processing between peer-to-peer printers can be generated. Therefore, optimal scheduling at any time from the data accumulated in the processing can be performed. Furthermore, it is possible to learn from the daily processing results and optimize the schedule as needed. Therefore, the job 230 can be processed efficiently. Further, the instruction information 420 can be used to perform optimal scheduling based on the condition to be prioritized.

On the other hand, the cost of production printing job includes the cost of paper, ink, electricity and depreciation costs for using component apparatuses, the labor (worker) costs of operators, and the like. Optimization to reduce these costs is carried out based on the experience of workers. For this reason, the optimization is a task that is dependent on the worker, and it is not always efficient.

In contrast, the industrial printing system X according to the present embodiment is an industrial printing system that performs production printing having a plurality of print servers 1 that perform distributed processing of a plurality of jobs 230, and each of the plurality of print servers 1 includes: a DB 210 that stores characteristic data 300 and processing result data 310 of processed jobs 230 and processing performance data 320 for a component apparatus; a learning unit 110 that learns a model 220 representing relationship between characteristics of a job 230, a processing result and a processing performance of the component apparatus based on the characteristic data 300, the processing result data 310, and the processing performance data 320 stored in the DB 210; and a learning unit 110 that learns a model 220 that shows the relationship between the characteristics of a job 230, the processing results, and the performance of the component apparatus; and a processing management unit 120 that outputs information on a setting of the job 230 for processing at optimal cost and scheduling allocation for own print server or other print server by using the model 220 learned by the learning unit 110 in accordance with instruction information 420 including condition to be prioritized.

As configured in this way, in an output environment that can be distributed peer-to-peer, it is possible to perform learning of the model 220 by using machine learning with information that is a factor in the printing cost and to perform setting of the job 230 and scheduling at the optimal cost with regard to the optimization of the printing cost, which is dependent on a worker. Thus, the job 230 in peer-to-peer can be processed at the optimal printing cost.

On the other hand, in a typical production printing system, there is a constant demand for high print quality, so there is a need to reduce printing costs and improve processing efficiency while ensuring print quality. In addition, in order to efficiently process large volumes of jobs, distributed printing processing by using a plurality of printers is also carried out.

In contrast, the industrial printing system X according to the present embodiment is an industrial printing system that performs production printing having a plurality of print servers 1 that perform distributed processing of a plurality of jobs 230, and each of the plurality of print servers 1 includes: a DB 210 that stores characteristic data 300 and processing result data 310 for processed jobs 230 and processing performance data 320 of a component apparatus; a learning unit 110 that learns a model 220 representing relationship between characteristics of a job 230, a processing result and a result of the component apparatus based on the characteristic data 300, the processing result data 310, and the processing performance data 320 stored in the DB 210; and a processing management unit 120 that outputs information on setting of the job 320 for processing at optimal quality and scheduling allocation for own print server or other print server by using the model 220 learned by the learning unit 110 in accordance with instruction information 420 including condition to be prioritized.

As configured in this way, for printing processes that can be distributed peer-to-peer by using printers, it is possible to optimize printing costs and printing processes while maintaining the printing quality that is currently dependent on the person. In other words, learning of model 220 by using the information that is a factor can be performed, and the optimal processing setting can be shown. Therefore, with regard to the optimization of the printing quality that are dependent on the person, it is possible to perform optimal job 230 settings and scheduling for the distribution of job 230 that emphasizes printing quality within the range of printing quality according to the priority condition. This makes it possible to perform settings and scheduling that has been dependent on the person as skill-less tasks, and it is also possible to perform training and optimization based on the daily processing results.

Further, in the industrial printing system X according to the present embodiment, the schedule management unit 100 sets the schedule setting 200 to be accessible to the other print server, restricts access to the schedule setting 200 for a specific period and/or a specific component apparatus from the other print server, and manages the system so that the unprocessed job 230 is not allowed to be allocated for the specific period and/or the specific component apparatus.

As configured in this way, the scheduling can be shared within print servers 1, which are in a peer-to-peer relationship. Thus, it is possible to restrict access from specific print server 1 and prevent them from being allocated job 230. Therefore, the job 230 can be processed in a peer-to-peer manner according to the user's environment. In addition, if the user does not hope to process the job 230 in a distributed manner, this can be addressed by restricting access, and security can be guaranteed.

Further, in the industrial printing system X according to the present embodiment, the DB 210 is set to be individually accessible or inaccessible for each information, and the learning unit 110 learns the model 220 by itself for information set to be inaccessible and shares the learned model 220 with other print server.

As configured in this way, it is possible to share information, schedule settings, cost condition information, or the like, accumulated in each print server 1 within the industrial printing system X. For example, the print server 1 requesting distributed processing can access the accumulated information of the print server 1 to which the request is sent. In addition, information that is not to be accessed can be restricted from access and kept confidential, thereby ensuring security.

Further, the Learning Unit 110 can accumulate, acquire, and share information that will result in the optimal schedule, printing cost, and/or quality by using AI, or the like. In other words, the information from not only the own print server but also the other print servers can be acquired and learned from it as training data for the model 220.

Furthermore, by learning about information for which access is restricted by the own print server, the model 220 can be trained while maintaining confidentiality. Therefore, it is possible to improve the schedule, cost, and quality of the entire industrial printing system X while restricting access to the stored information.

Further, in the industrial printing system X according to the present embodiment, when there is a possibility of delay in delivery date of requested job 230, the schedule management unit 100 of the print server 1 that has received the request for the job 230 notifies delay status to the print server 1 that requests the job 320, and the processing management unit 120 of the print server 1 that requests the job 230 updates the schedule setting 200 and re-allocates the unprocessed job 230.

As configured in this way, sudden delays in delivery dates, or the like, can be responded, flexibly. As a result, more optimal scheduling can be performed.

Further, in the industrial printing system X according to the present embodiment, the processing management unit 120 calculates the expected profit after scheduling by using the model 220 and makes a proposal to increase profit by changing the instruction information 420.

As configured in this way, profit maximization by using AI, or the like, can be achieved. Thus, the reduction of costs by distributed processing can be optimized.

Further, in the industrial printing system X according to the present embodiment, the instruction information 420 includes an instruction to either change set value or process as is when there is a possibility that the expected profit will be less than or equal to the set value of lower limit, and the processing management unit 120 updates the schedule setting 200 and the re-allocates the unprocessed jobs 230 when the set value is changed.

As configured in this way, when the expected profit falls below the set value of lower limit, it is possible to warn the user and allow them to choose whether to continue with the schedule as it is or perform re-scheduling. Therefore, distributed processing of printing at a cost that is in line with the user's intention can be executed.

Further, in the industrial printing system X according to the present embodiment, the processing management unit 120 calculates the expected quality value after scheduling by using the model 220 and makes a proposal to improve quality by changing the instruction information 420.

As configured in this way, it is possible to maximize the improvement in quality using AI, or the like. Therefore, even if distributed processing is performed, quality can be improved.

Further, in the industrial printing system X according to the present embodiment, the instruction information 420 includes instructions to change the set value or to process as is when there is a possibility that the expected quality value will be less than or equal to the set value of lower limit, and the processing management unit 120 updates the schedule setting 200 and re-allocate the unprocessed job 230 when the set value is changed.

As configured in this way, even if the expected quality value falls below the set value of lower limit, it is possible to warn the user and allow them to choose whether to continue with the schedule as it is or re-schedule. Therefore, distributed processing of printing can be executed with a quality that matches the user's intention.

In the industrial printing system X according to the present embodiment, the characteristic data 300 of the job 230 includes size information 301, content information 302, and post-processing information 303; the processing result data 310 includes output number information 312, processing result information 313, processing time information 314, and processing cost information 315; and the processing performance data 320 includes processing capacity information 321, operation performance information 322, and color management information 323.

As configured in this way, it is possible to estimate processing time from the contents of job 230 and allocate job 230 to match the processing capacity of the print server 1 and the component apparatus. Further, scheduling can be performed while taking into account the processing order of the job 230 to minimize the need to set change in the component apparatus, periodical color management operation to maintain color quality, and downtime due to errors or malfunctions of component apparatuses. Therefore, the job 230 can be allocated, efficiently. As a result, the job 230 can be output at low cost and high quality.

In addition, efficient processing of the job 230 by taking into account the processing capacity and setting status of the component apparatus can be performed. Also, set change such as changing the paper, or the like, in the time of printing can be minimized. As a result, it is possible to streamline printing work, reduce costs, and suppress quality degradation due to changes, or the like. In addition, an autonomous automated system in which the print server 1 judges the processing status of the component apparatus and performs processing can be constructed.

Further, in the industrial printing system X according to the present embodiment, the DB 210 further accumulates the operator's work performance information 330; the learning unit 110 learns the model 220 by adding the relationship between the operator and the work performance information 330; and the processing management unit 120 outputs the information on the allocation of the operator.

As configured in this way, the most suitable operator for the job 230 can be assigned even in a peer-to-peer environment. This allows the most suitable operator to process the job in terms of cost and quality and to print in accordance with the user's intention.

In addition, in the industrial printing system X according to the present embodiment, the DB 210 further accumulates the weather information 340 when processing, and the learning unit 110 also learns the weather information 340 to the model 220.

As configured in this way, the relationship between the weather information 340 and the weather change information 324 can also be learned to the model 220, and corrections can be made according to the forecasted weather. As a result, corrections can be made automatically, objectively, and with high quality rather than being adjusted manually. This reduces wastage, or the like, and also reduces costs.

In the industrial printing system X according to the present embodiment, the DB 210 further stores order information 350 indicating the busy periods of orders and the trends of sudden orders, and the learning unit 110 learns relationship between the schedule setting 200 and the order information 350 to the model 220.

As configured in this way, it is possible to perform scheduling at optimal cost and quality according to the relationship between the schedule and the order.

In the industrial printing system X according to the present embodiment, the processing management unit 120 further outputs the possibility of handling sudden orders by using the model 220.

As configured in this way, it is possible to present the user the expected number of sudden orders, that is, how many sudden orders can be handled. This allows the user to schedule jobs 230 for sudden orders, even in a peer-to-peer environment, by setting up free time and free print servers 1.

In the industrial printing system X according to the present embodiment, the job 230 includes delivery date information 410, and the processing management unit 120 performs scheduling based on the conditions to be prioritized the delivery date information 410 or the cost, and the threshold of the completion processing time of the job 230.

As configured in this way, the job 230 can be assigned based on the deadline or cost set for the job 230 itself. Furthermore, by scheduling based on the completion threshold set for the job 230, it is possible to process the job 230 appropriately according to the user's intention.

[Other embodiments]

In the above-mentioned embodiment, an example describes a case where the model 220 is shared with the print servers 1 in the industrial printing system X.

However, the model 220 may be learned, separately, by each print server 1. In such case, when scheduling is performed by the own print server, the model 220 learned by the own print server may be used for the allocation of the job 230 to the other print servers.

In this case, due to restrictions on shared information between print servers 1, it is not always possible to train the same model 220 of AI, or the like, on each print server 1. For this reason, it is also possible that output by the model 220 is performed on the own print server for processing job 230 at the own print server. Similarly, the output by the model 220 can be performed on the other print server for processing job 230 at the other print server.

Alternatively, it is also possible to compare this setting and scheduling with the optimal settings and scheduling output by model 220 on the requesting print server 1. In this case, if even more optimal settings or scheduling can be obtained for the target quality or condition to be prioritized, it is also possible to propose these to the requesting destination or the requesting source. Furthermore, it is also possible to perform scheduling by using the plurality of print servers 1 with the separately learned model 220 and to select the best one by majority vote. In such case, the model 220 in the best print server 1 can be shared with the plurality of print servers 1.

Further, in the above-mentioned embodiment, an example in which learning and the allocation of an unprocessed job 230 are performed, sequentially, is described.

However, it is also possible to handle this by separate processes, such as only learning the model 220 and only scheduling the allocation of the job 230 by using the trained model 220. In such case, the model 220 may be trained and scheduled in a distributed manner on separate print servers 1. The print servers 1 to be distributed may be selected in order of higher-performance, may be selected from print servers 1 that do not perform rasterization, or the like, and have a lot of available space in scheduling, or may be selected randomly.

As configured in this way, it is possible to perform more optimal scheduling, reduce costs, and improve quality.

Further, in the above-mentioned embodiment, an example in which the model 220 is learned without distinguishing between the rasterization process, printing process, and post-processing process of the job 230 is described.

However, it is also possible to learn separate models 220 for the rasterization process, printing process, and post-processing process.

As configured in this way, it is possible to generate a more accurate model 220 by fine-tuning, or the like, according to the type and number of component apparatuses for each process.

Furthermore, in the above-mentioned embodiment, an example that the condition to be prioritized in the instruction information 420 indicates cost or quality is described.

However, it is also possible to set both of these and, for example, how cost and quality are prioritized is feelingly adjusted in a form such as a slide bar. In this case, it is also possible to present changes in the expected profit and expected quality values after scheduling by moving the slide bar, or the like.

Also, it may be possible to set whether to prioritize cost or quality depending on the characteristics and processing settings of the job 230.

Furthermore, it may be possible to configure these settings in a format similar to a macro language.

Further, in the above-mentioned embodiment, an example that sets the lower limit of the expected profit and quality values according to the user's instruction is described.

However, the learning unit 110 can learn these values into the model 220 and output the set value. In such case, it is possible to set the average value for systems with similar component apparatuses and print servers 1.

The output of the model 220 may also provide a list of expected profit and expected quality values for the print servers 1 and component apparatuses, respectively, which may be presented to the user in terms of whether they are low or high.

This configuration makes it more user-friendly and helps with planning printing and business.

In addition, it may be possible to set which condition is prioritized, such as the condition that prioritizes delivery date, the condition that prioritizes operating rate, and the condition that prioritizes the number of processing jobs.

As configured in this way, it is possible to process the job 230 with the optimal cost, quality, delivery date, operating rate, and number of processed jobs in accordance with the user's or the order's intention.

Further, in the above-mentioned embodiment, the instruction information 420 is provided for each the job 230 is described.

However, for the unprocessed jobs 230, it may be configured so that the user's policy is to give overall processing instruction from the management terminal 6. It is also possible to group the jobs 230 and give instructions. It is also possible to set the instruction information 420 for each print server 1 or location. Furthermore, it is possible to change the processing instruction based on the above-mentioned access setting of the schedule setting 200 or the information access setting 211 of the DB 210.

As configured in this way, it is not necessary to give instructions on a job 230-by-job basis, or it is possible to give detailed processing instructions, which improves usability.

In the industrial printing system X of the above-mentioned embodiment, the job 230 includes the instruction information 420 indicating whether the delivery date or the cost should be given priority, and the processing management unit 120 may perform scheduling based on the instruction information 420 of the job 230.

As configured in this way, scheduling can be performed based on the instruction information 420 set in the job 230 itself. This allows efficient scheduling to be performed by combining the user's instructions with the instruction information 420 of the job 230 itself.

Further, in the above-described embodiment, an example of a system in which plurality of print servers 1 are connected in a peer-to-peer manner is described.

However, even in a peer-to-peer system, it is also possible to configure a system so that the DFE of the component apparatus allocates the job 230 to the DFE of the peer-to-peer system without using the print server 1. In such case, for example, the representative print apparatus 2 may be set in place of the representative print server 1 for the job 230, and the representative print apparatus 2 may perform the same processing as the DFE. Furthermore, it is also possible for the component apparatuses to transfer the job 230 to each other.

Alternatively, a management server may be set, and a print server 1 of a single workflow system may be used to generate a job 230 and allocate the job 230 to a component apparatus connected with the management server.

As configured in this way, the printing process of the jobs 230 can be made more efficient depending on the environment.

In the above-mentioned embodiment, an example in which information on the optimal setting of the unprocessed job 230 and the allocation of scheduling is output, sequentially, by the user instruction is described.

However, the processing management unit 120 may notify the management terminal 6 when the set time, set interval, or number of acquired jobs 230 reaches the set value of the condition, and obtain the user instruction.

As configured in this way, the learning of the model 220 and the allocation of jobs 230 can be optimized. It is also possible to start scheduling with any condition set by the user. Therefore, in the user's environment, learning, configuration and scheduling output, allocation of the jobs 230 can be performed at the appropriate time. As a result, the jobs 230 are processed, efficiently, and at low cost.

In the above-mentioned embodiment, an example of executing jobs 230 as they are is described.

However, it is also possible to change the job 230 itself in response to the status notification, the completion notification, the error notification, or the like, for each job 230.

In such case, it is also possible to change the job 230 in response to processing change information or alternative setting. That is, when adjusting a processing request due to a delay, for example, it is possible to change the number of pages, the color profile to be used, or the like, for the processable job 230 according to alternative setting. Furthermore, a model 220 that takes these into account can be prepared.

Further, in the above-mentioned embodiment, an example in which a job 230 is allocated to one of the available spaces in the available space setting 202 of the schedule setting 200 is described.

However, if there is not enough time to allocate the job 230 to the available space, or if the number of pages or copies in the job 230 is large, it is also possible to divide the job 230 and allocate them to different available spaces. Furthermore, it is also possible to divide the job and allocate it to the available space of each component apparatus by requesting the processing of the divided jobs to print servers 1 at different locations.

As configured in this way, flexible processing can be performed. In addition, it is possible to effectively utilize the available capacity and increase the operating rate of each print server 1.

In addition, in the terminology used in this specification, the singular forms “a”, “an” and “the” also include the plural forms unless the context clearly indicates otherwise.

It goes without saying that the configuration and operation of the above-mentioned embodiments are examples, and that they can be changed and executed as appropriate within the scope of not deviating from the purpose of the present disclosure.

What is claimed is:

1. An industrial printing system that performs production printing having a plurality of print servers for distributed processing of a plurality of jobs, each of the plurality of print servers comprising:
a schedule management unit configured to manage scheduling setting of processing of a job for a component apparatus;
a database that stores characteristic data and processing result data for processed jobs and processing performance data for the component apparatus;
a learning unit configured to learn a model for optimally allocating jobs to the component apparatus based on the characteristic data, processing result data, and processing performance data stored in the database; and
a processing management unit configured to allocate an unprocessed job to an available space in the schedule setting based on output result of the model for the unprocessed job in accordance with the instruction information including a condition to be prioritized, cause corresponding component apparatus to process the unprocessed job, or transmit the unprocessed job to other print server and request processing of the unprocessed job.

2. The industrial printing system according to claim 1, wherein
the schedule management unit sets the schedule setting to be accessible by the other print server, restricts access to the schedule setting for a specific period and/or a specific component apparatus from the other print server, and manages the system so that the unprocessed job is not allowed to be allocated for the specific period and/or the specific component apparatus.

3. The industrial printing system according to claim 1, wherein
the database is set to be individually accessible or inaccessible for each information, and
the learning unit learns the model by itself for the information set to be inaccessible and shares the learned model with the other print server.

4. The industrial printing system according to claim 1, wherein
when there is a possibility of delay in delivery of requested job, the schedule management unit of print server that has received job requests notifies delay status to print server that requests the job, and
the processing management unit of the print server that requests the job updates the schedule setting and re-allocates the unprocessed job.

5. The industrial printing system according to claim 1, wherein
the characteristic data of the job includes size information, content information, and post-processing information;
the processing result data includes output number information, processing result information, processing time information, and processing cost information; and
the processing performance data includes processing capacity information, operation performance information, and color management information.

6. A print server that performs distributed processing of a plurality of jobs in an industrial printing system that performs production printing, comprising:
a schedule management unit configured to manage scheduling setting of processing of a job for a component apparatus;
a database that stores characteristic data and processing result data for processed jobs and processing performance data for the component apparatus;
a learning unit configured to learn a model for optimally allocating jobs to the component apparatus based on the characteristic data, processing result data, and processing performance data stored in the database; and
a processing management unit configured to allocate an unprocessed job to an available space in the schedule setting based on output result of the model for the unprocessed job in accordance with the instruction information including a condition to be prioritized, cause corresponding component apparatus to process the unprocessed job, or transmit the unprocessed job to other print server and request processing of the unprocessed job.

7. The print server according to claim 6, wherein
the schedule management unit sets the schedule setting to be accessible by the other print server, restricts access to the schedule setting for a specific period and/or a specific component apparatus from the other print server, and manages the system so that the unprocessed job is not allowed to be allocated for the specific period and/or the specific component apparatus.

8. The print server according to claim 6, wherein
the database is set to be individually accessible or inaccessible for each information, and
the learning unit learns the model by itself for the information set to be inaccessible and shares the learned model with the other print server.

9. The print server according to claim 6, wherein
when there is a possibility of delay in delivery of requested job, the schedule management unit of print server that has received job requests notifies delay status to print server that requests the job, and
the processing management unit of the print server that requests the job updates the schedule setting and re-allocates the unprocessed job.

10. The print server according to claim 6, wherein
the characteristic data of the job includes size information, content information, and post-processing information;
the processing result data includes output number information, processing result information, processing time information, and processing cost information; and
the processing performance data includes processing capacity information, operation performance information, and color management information.

11. A processing management method executed by an industrial printing system that performs production printing having a plurality of print servers for distributed processing of a plurality of jobs, comprising the steps of:
managing scheduling setting of processing of a job for a component apparatus;
storing characteristic data and processing result data for processed jobs and processing performance data for the component apparatus;
learning a model for optimally allocating jobs to the component apparatus based on the characteristic data, processing result data, and processing performance data that are stored; and
allocating an unprocessed job to an available space in the schedule setting based on output result of the model for the unprocessed job in accordance with the instruction information including a condition to be prioritized, cause corresponding component apparatus to process the unprocessed job, or transmit the unprocessed job to other print server and request processing of the unprocessed job.

12. The processing management method according to claim 11, further comprising a step of:
setting the schedule setting to be accessible by the other print server, restricts access to the schedule setting for a specific period and/or a specific component apparatus from the other print server, and manages the system so that the unprocessed job is not allowed to be allocated for the specific period and/or the specific component apparatus.

13. The processing management method according to claim 11, further comprising the steps of:
setting to be individually accessible or inaccessible for each information; and
learning the model by itself for the information set to be inaccessible and shares the learned model with the other print server.

14. The processing management method according to claim 11, further comprising the steps of:
notifying, when there is a possibility of delay in delivery of requested job, from print server that has received job requests delay status to print server that requests the job; and
updating the schedule setting and re-allocates the unprocessed job on the print server that requests the job.

15. The processing management method according to claim 11, wherein:
the characteristic data of the job includes size information, content information, and post-processing information;
the processing result data includes output number information, processing result information, processing time information, and processing cost information; and
the processing performance data includes processing capacity information, operation performance information, and color management information.
